(19) United States
(12) Patent Application Publication
(10) Pub. No.: US 2004/0100476 A1
(43) Pub. Date: May 27, 2004

(54) Method and apparatus for viewing computer aided detection and diagnosis results

(76) Inventors: Mark M. Morita, Arlington Heights, IL (US); William Murray Stoval, III, Mt. Prospect, IL (US); Steven Lawrence Fors, Chicago, IL (US); Charles Cameron Brackett, Naperville, IL (US); David S. Channin, Evanston, IL (US)

Correspondence Address: Patrick S. Yoder, Fletcher, Yoder & Van Someren, P.O. Box 692289, Houston, TX, 77269-2289, US

(21) Appl. No.: 10/303,220

(22) Filed: Nov. 25, 2002

(51) Int. Cl. H04N 7/18; H04N 9/47; G09G 5/00

(52) U.S. Cl. 345/619

(57) ABSTRACT

A technique is provided for the displaying a visual aid tool to facilitate the review of image data which has undergone processing by one or more computer-implemented routines. In particular, the display of the visual aid tool does not obstruct structures of interest in the image which have been identified by the computer-implemented routines. The visual aid tool may allow the magnification of an identified structure, may display relevant information for reviewing the structure, and may allow toggling between result sets for different computer-implemented routines available to process the image data. In addition the visual aid tool may be customized to reflect the preferences or tendencies of individual operators.

### BACKGROUND OF THE INVENTION

The present technique relates generally to image analysis techniques and more particularly to the use of computer-implemented routines to detect and classify structures within an image. More specifically, the present technique relates to viewing the results of computer-implemented detection and classification routines, such as those applied in the field of medical imaging.

Various technical fields engage in some form of image evaluation and analysis in which the detection and classification of recognizable features within the image data is a primary goal. For example, medical imaging technologies produce various types of diagnostic images which a doctor or radiologist may review for the presence of identifiable features of diagnostic significance. Similarly, in other fields, other features may be of interest. By way of example only, the analysis of satellite and radar weather data may involve the determination of what weather formations, such as tornados or other violent storms, are either present in the image data or are in the process of forming. Likewise, evaluation of astronomical and geological data represented visually may also involve similar feature identification exercises. With the development of digital imaging and image processing techniques, the quantity of readily available image data requiring analysis in many of these technical fields has increased substantially.

Indeed, the increased amounts of available image data may inundate the human resources, such as trained technicians, available to process the data. To aid these technicians, computer-implemented techniques may be employed. For example, these techniques may provide a preliminary analysis of the image data, flagging areas of interest for subsequent review by a trained technician.

For example, in the realm of medical imaging, computer assisted detection and diagnosis (CAD) algorithms have been developed to supplement and assist radiologists in the review of diagnostic images. CAD is typically based upon various types of image analysis implementations in which the collected image is analyzed in view of certain known pathologies that may be flagged by the CAD algorithm. CAD has been developed to complement various medical imaging modalities including digital X-ray, magnetic resonance imaging, ultrasound and computed tomography. The development of CAD for these various modalities is generally desirable because CAD provides valuable assistance and time-savings to the reviewing radiologist.

As noted with regard to CAD, computer assistance is typically employed initially to analyze image data and to highlight regions of interest for further review by a trained technician. One issue which arises in the deployment of CAD and related technologies is the graphical interface by which the CAD results may be conveyed to an operator. Because both the data and the results may be complex, it may be desirable to simplify the findings or to focus the attention of the technician to specific aspects of the data or the results. This may be particularly desirable in situations such as medical diagnosis where the time a technician spends analyzing the data may delay diagnosis and treatment, and where, owing in part to the high degree of specialization of the medical professionals, little time is available to analyze results of many examination sequences and individual images.

There is a need, therefore, for techniques for conveying the results of computer-assisted analysis, such as CAD, to a reviewing technician or clinician in a simplified or streamlined manner.

### BRIEF DESCRIPTION OF THE INVENTION

The present invention provides a technique for employing a visual aid tool to facilitate the review of a computer-implemented analysis of a set of image data. The visual aid tool includes a viewing window which emphasizes structures identified during the computer-implemented analysis without obscuring the structures. In addition, the visual aid tool may include a set of viewing tools which may be customizable to individual operators. The viewing tools may provide such information as the current configuration of the computer-implemented analysis, results of the analysis, such as classifications and probabilities, selectable options and acknowledgements, and toggle buttons which allow the result sets for different computer-implemented analyses to be viewed.

In accordance with one aspect of the present technique, a method for facilitating review of a computer-processed image is provided. A computer-processed image, which includes one or more structures selected by a computer routine, is displayed. In addition, at least one visual aid tool is displayed. The visual aid tool comprises a viewing window such that the viewing window encompasses one or more structures.

In accordance with another aspect of the present technique, a method is provided for reviewing a computer-processed image. A first set of CAD results generated by a first CAD algorithm is viewed. A second CAD algorithm is selected and a second set of CAD results generated by the second CAD algorithm is viewed.

In accordance with an additional aspect of the present technique, an image analysis system is provided. The system includes data processing circuitry configured to apply at least one computer analysis routine to an image data set to produce a respective computer-processed image data set. The computer-processed image data set includes one or more structures selected by the computer analysis routine. The system also includes an operator interface configured to display the respective computer-processed image data set. The operator interface is also configured to display at least one visual aid tool comprising a viewing window, which encompasses at least one structure.

In accordance with an additional aspect of the present technique, an image analysis system is provided. The system includes data processing circuitry configured to apply a first CAD algorithm to an image data set to generate a first set of CAD results. The data processing circuitry is also configured to apply a second CAD algorithm to the image data set to generate a second set of CAD results. The system also includes an operator interface configured to allow an operator to select one of the first set of CAD results and the second set of CAD results for display.

In accordance with another aspect of the present technique, an image analysis system is provided. The system includes data processing circuitry configured to apply at least one computer analysis routine to an image data set to produce a respective computer-processed image data set. The respective computer-processed image data set includes one or more structures selected by the computer analysis routine. The system also includes an operator interface, which includes a means for displaying a visual aid tool in conjunction with the respective computer processed data set.

In accordance with a further aspect of the present technique, an image analysis system is provided. The system includes data processing circuitry configured to apply a selected CAD algorithm from two or more possible CAD algorithms to an image data set to generate a selected set of CAD results. The system also includes an operator interface comprising a means for selecting the selected CAD algorithm.

In accordance with an additional aspect of the present technique, a tangible medium for facilitating review of a computer-processed image is provided. The tangible medium includes a routine for displaying a computer-processed image. The computer-processed image comprises one or more structures selected by a computer routine. The tangible medium also includes a routine for displaying at least one visual aid tool comprising a viewing window such that the viewing window encompasses one or more structures.

In accordance with a further aspect of the present technique, a tangible medium for reviewing a computer-processed image is provided. The tangible medium includes a routine for viewing a first set of CAD results generated by a first CAD algorithm. The tangible medium also includes a routine for selecting a second CAD algorithm and a routine for viewing a second set of CAD results generated by the second CAD algorithm.

### BRIEF DESCRIPTION OF THE DRAWINGS

The foregoing and other advantages and features of the invention will become apparent upon reading the following detailed description and upon reference to the drawings in which:

FIG. 1 is a general diagrammatical representation of certain functional components of an exemplary image data-producing system, in the form of a medical diagnostic imaging system;

FIG. 2 is a diagrammatical representation of a particular imaging system of the type shown in FIG. 1, in this case an exemplary X-ray imaging system which may be employed in accordance with certain aspects of the present technique;

FIG. 3 is a flowchart depicting the processing of image data by one or more CAD algorithms;

FIG. 4 is a representation of one implementation of a visual aid tool in accordance with one aspect of the present technique;

FIG. 5 is a representation of another implementation of a visual aid tool in accordance with one aspect of the present technique;

FIG. 6 is a representation of a further implementation of a visual aid tool in accordance with one aspect of the present technique;

FIG. 7 is a representation of an additional implementation of a visual aid tool in accordance with one aspect of the present technique; and

FIG. 8 is a representation of a series of CAD processed medical images which are displayed in conjunction with visual aid tools as depicted in FIGS. 4-7.

### DETAILED DESCRIPTION OF SPECIFIC EMBODIMENTS

The present technique pertains to the computer-assisted processing of digital image data of various sorts. For simplicity, and in accordance with a presently contemplated implementation, the following example discusses the technique in the context of medical imaging. However it is to be understood that the technique is not limited to medical imaging. Instead, any digital imaging implementation in which computer-aided analysis of the image data may occur and in which the results of such an analysis are presented to an operator for review may benefit from the following technique. For example, digital image data of a general or technical nature, such as meteorological, astronomical, and geological, which may employ computer-implemented routines to assist a human agent in feature identification and classification may benefit from the present technique.

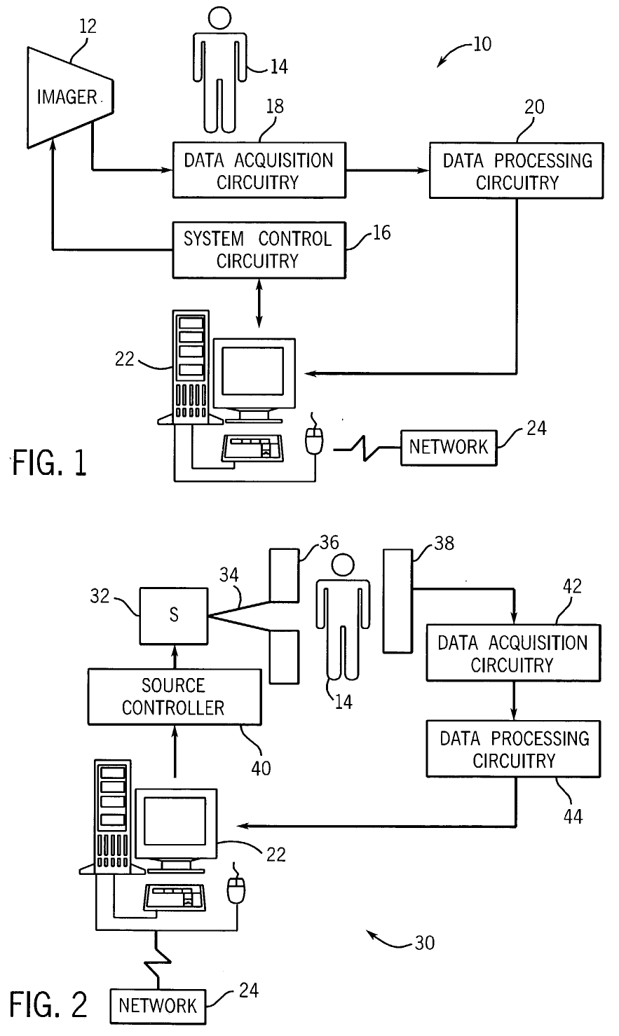

In the context of medical imaging, various imaging resources may be available for diagnosing medical events and conditions in both soft and hard tissue, and for analyzing features and function of specific anatomies. FIG. 1 provides a general overview for exemplary imaging systems, and subsequent figures offer somewhat greater detail into the major system components of a specific modality system. Such medical imaging systems may include, but are not limited to, medical imaging modalities such as digital X-ray, Computed Tomography (CT), Magnetic Resonance Imaging (MRI), and Positron Emission Tomography (PET). Throughout the discussion, however, it should be borne in mind that the present techniques may be applied to image data produced by any such system or modality, and is generally independent of the system or modality used to acquire the image data. That is, the technique may operate on stored raw, processed or partially processed data from any suitable source.

Referring to FIG. 1, an imaging system 10 generally includes some type of imager 12 which detects signals and converts the signals to useful data. As described more fully below, the imager 12 may operate in accordance with various physical principles for creating the image data. In general, however, in the medical imaging context image data indicative of regions of interest in a patient 14 are created by the imager in a digital medium.

The imager 12 operates under the control of system control circuitry 16. The system control circuitry 16 may include a wide range of circuits, such as radiation source control circuits, timing circuits, circuits for coordinating data acquisition in conjunction with patient or table of movements, circuits for controlling the position of radiation or other sources and of detectors, and so forth. The imager 12, following acquisition of the image data or signals, may process the signals, such as for conversion to digital values, and forwards the image data to data acquisition circuitry 18. In digital systems, the data acquisition circuitry 18 may perform a wide range of initial processing functions, such as adjustment of digital dynamic ranges, smoothing or sharpening of data, as well as compiling of data streams and files, where desired. The data are then transferred to data processing circuitry 20 where additional processing and analysis are performed. For the various digital imaging systems available, the data processing circuitry 20 may perform substantial analyses of data, ordering of data, sharpening, smoothing, feature recognition, and so forth.

Ultimately, the image data are forwarded to some type of operator interface 22 for viewing and analysis. While operations may be performed on the image data prior to viewing, the operator interface 22 is at some point useful for viewing and manipulating reconstructed images based upon the image data collected. The images may also be stored in short or long-term storage devices, for the present purposes generally considered to be included within the interface 22, such as picture archiving communication systems. The image data can also be transferred to remote locations, such as via a network 24. It should also be noted that, from a general standpoint, the operator interface 22 affords control of the imaging system, typically through interface with the system control circuitry 16. Moreover, it should also be noted that more than a single operator interface 22 may be provided. Accordingly, an imaging scanner or station may include an interface 22 which permits regulation of the parameters involved in the image data acquisition procedure, whereas a different operator interface 22 may be provided for manipulating, enhancing, and viewing resulting reconstructed images.

To discuss the technique in greater detail, a specific medical imaging modality based upon the overall system architecture outlined in FIG. 1 is depicted in FIG. 2. FIG. 2 generally represents a digital X-ray system 30. System 30 includes a radiation source 32, typically an X-ray tube, designed to emit a beam 34 of radiation. The radiation may be conditioned or adjusted, typically by adjustment of parameters of the source 32, such as the type of target, the input power level, and the filter type. The resulting radiation beam 34 is typically directed through a collimator 36 which determines the extent and shape of the beam directed toward patient 14. A portion of the patient 14 is placed in the path of beam 34, and the beam impacts a digital detector 38.

Detector 38, which typically includes a matrix pixels, encodes intensities of radiation impacting various locations in the matrix. A scintillator converts the high energy X-ray radiation to lower energy photons which are detected by photodiodes within the detector. The X-ray radiation is attenuated by tissues within the patient, such that the pixels identify various levels of attenuation resulting in various intensity levels which will form the basis for an ultimate reconstructed image.

Control circuitry and data acquisition circuitry are provided for regulating the image acquisition process and for detecting and processing the resulting signals. In particular, in the illustration of FIG. 2, a source controller 40 is provided for regulating operation of the radiation source 32. Other control circuitry may, of course, be provided for controllable aspects of the system, such as a table position, radiation source position, and so forth. Data acquisition circuitry 42 is coupled to the detector 38 and permits readout of the charge on the photo detectors following an exposure. In general, charge on the photo detectors is depleted by the impacting radiation, and the photo detectors are recharged sequentially to measure the depletion. The readout circuitry may include circuitry for systematically reading rows and columns of the photo detectors corresponding to the pixel locations of the image matrix. The resulting signals are then digitized by the data acquisition circuitry 42 and forwarded to data processing circuitry 44.

The data processing circuitry 44 may perform a range of operations, including adjustment for offsets, gains, and the like in the digital data, as well as various imaging enhancement functions. The resulting data are then forwarded to an operator interface or storage device for short or long-term storage. The images reconstructed based upon the data may be displayed on the operator interface, or may be forwarded to other locations, such as via a network 24, for viewing. Also, digital data may be used as the basis for exposure and printing of reconstructed images on a conventional hard copy medium such as photographic film.

When in use, the digital X-ray system 30 acquires digital X-ray images of a portion of the patient 14 which may then be analyzed for the presence of indicia of one or more medical pathologies such as lesions, masses, nodules, fractures, microcalcifications, etc. Other imaging modalities of course may be better suited for detecting different types of anatomical features.

As will be appreciated by those skilled in the art, computer aided detection and/or diagnosis (CAD) algorithms may offer the potential for localizing and identifying structures of interest, such as pathologies or anomalies, within an imaged region and differentially processing such structures. The particular CAD implementation employed may be selected based upon the type of feature to be identified and upon the imaging modality used to create the image data. CAD algorithms may be considered as including various modules or subroutines for processing the image data.

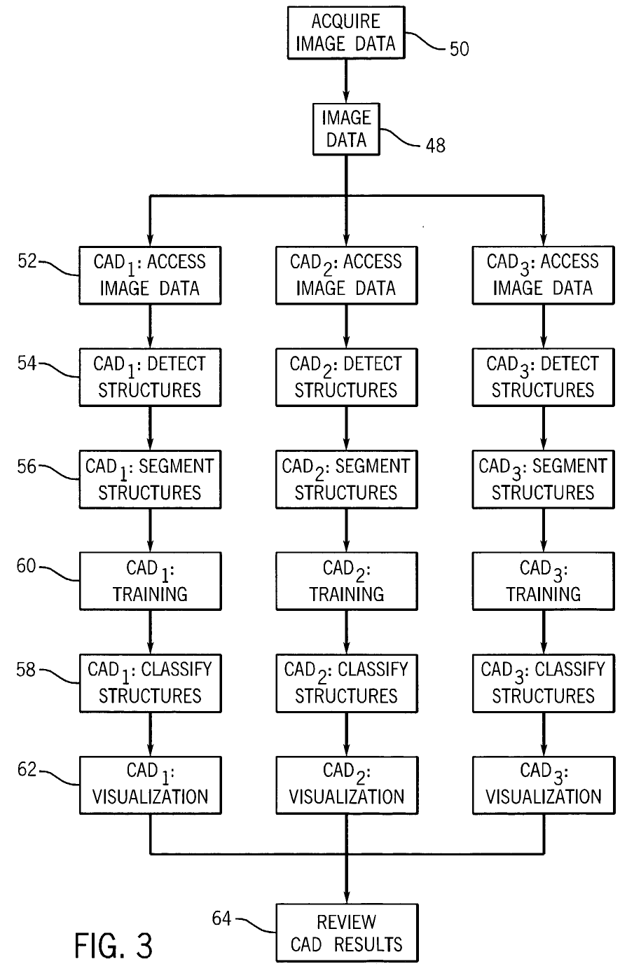

In addition, alternate CAD algorithms based upon different mathematical models or assumptions may be available to analyze a given set of image data. For example, referring to FIG. 3, an imaging system 10 may acquire image data 48, as indicated as step 50. The image data 48 may be susceptible to singular or parallel processing by any one of a number of CAD algorithms, such as the CAD₁, CAD₂ and CAD₃ depicted.

Referring to those exemplary steps implemented by CAD,, it can be seen that the acquired image data 48 is accessed at step 52 and processed to detect structures at step 54. As noted above, the data may be accessed as it is produced (i.e. acquired), or may be subsequently accessed, such as from a Picture Archiving and Communications System (PACS) in a medical diagnostic imaging context. The step of structure detection may include a variety of subprocesses, typically based upon the type of image, the type of feature (i.e. pathology) to be recognized, and the anatomy viewed in the image, in the medical context. In practice, a CAD algorithm may be adapted for recognition of one or more particular types of structures or features, such as those expected to occur in mammography images, for example. The features are recognized by characteristic attributes known to be exhibited by such features, generally on a statistical basis, based upon prior analysis of a population of images and, typically, with consideration of experience of expert technicians or radiologists.

In addition, at step 56, the CAD technique may segment the detected structures. Again, various segmentation algorithms may be incorporated in the CAD algorithm. Such segmentation algorithms will separate detected structures from the image background by reference to known or anticipated image characteristics, such as edges, identifiable features, boundaries, changes or transitions in colors or intensities, changes or transitions in spectrographic information, and so forth.

Once segmented, the CAD algorithm may classify the segmented structures by pathology type, prognosis, statistical certainty or various other classification schemes, as depicted at step 58. As with the initial feature detection, the classification function performed by the CAD algorithm is based upon comparison to known characteristic attributes of similarly classified features, usually for a specific pathology, anatomical region, and image type. Once the CAD algorithm has processed the image data 48, the image data 48 and CAD result may be visualized, as depicted at step 62, for review by a technician or clinician, as depicted at step 64. Subsequent processing and data acquisition may then be requested at the discretion of the practitioner.

The CAD algorithm may also include a training step 60 whereby the CAD algorithm refines the operation other modules, such as detection, segmentation, or classification. The training step 60 may consider a wide variety of factors such as historical performance of the algorithm or patient specific factors, such as prior conditions and family history. For example, the training step 60 may access such resources as a hospital or enterprise wide database of accumulated images and diagnoses.

The general steps of detection, segmentation and classification may vary according to particular CAD algorithms, such as due to the mathematical models on which the particular algorithms are based. Moreover, it should be noted that such algorithms will typically include various parametric settings which may be fixed in advance, or available for adjustment by the user, as described below. For example, sensitivity settings, various “filtering” settings, segmentation stopping settings, and settings used in the classification step may be subject to variation which could result in somewhat different detection, segmentation and classification results. In practice, and as also described below, the technician may desire more or less stringent “filtering” of particular CAD routines on sets of image data to provide more or less information, reduce or increase “positive” result occurrences, and so forth. The present technique facilitates such adjustment without obscuring underlying image presentation.

The described CAD modules and processes are not intended to be either exhaustive or restrictive. CAD modules performing different processing steps than those described may be present. Likewise, the various possible CAD modules described may or may not all be implemented in the present technique. In addition, due to the different mathematical models and assumptions of different CAD algorithms, such as CAD₁, CAD₂ and CAD₃ of FIG. 3, the results of each CAD algorithm may differ. Indeed, particular algorithms may be preferred or optimized for particular circumstances or conditions.

In practice, CAD results may be displayed by overlaying the image data 48 with geometric or colored markers at the site of an identified structure. The shape or color of the marker may also be indicative of a classification assigned to the structure by the CAD algorithm. Text may be associated with the marker, such as a probability assessment. These approaches, however, have the drawback of potentially obscuring the feature of interest and, further, may not facilitate the rapid analysis of what may be a complex image. In addition, surrounding tissue in the image, which may not be of interest, may be distracting, encouraging a reviewing technician to spend time assessing the entire image as opposed to only the structures of interest, thereby losing some of the time advantages associated with CAD pre-processing.

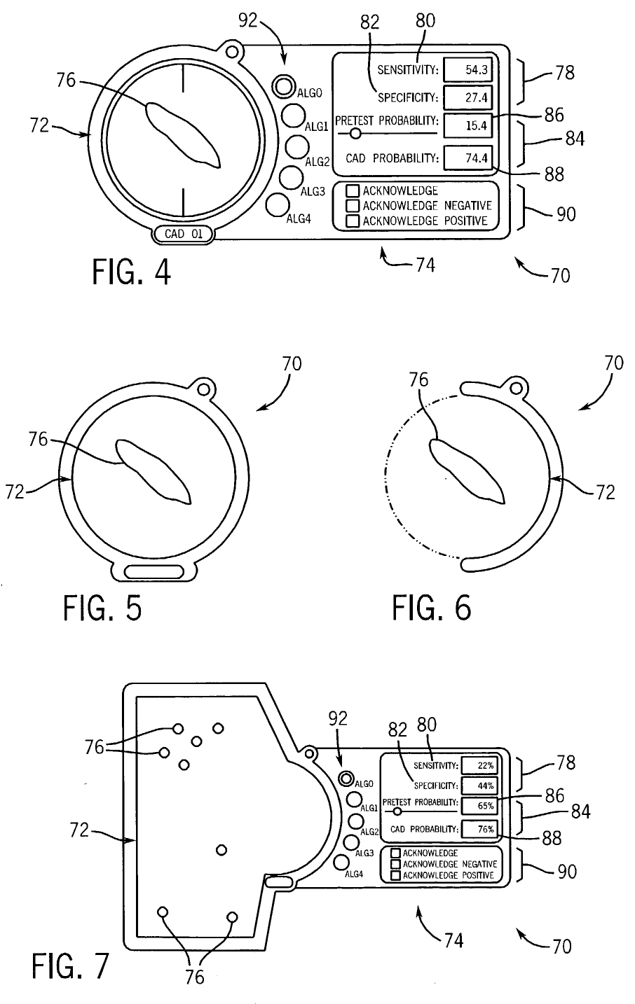

The present technique offers a visual aid tool (VAT) to indicate structures of interest in the CAD processed data. Such a tool may be used to review CAD results at different steps in the CAD process, such as after the segmentation step 56 or the classification step 58, depending on the type of review desired. The VAT may be implemented as a graphical user interface (GUI) object or may be implemented as code that is either run at a user workstation (i.e. downloaded) or remotely, or a combination of these. For example, as depicted in FIG. 4, the VAT 70 may be implemented as a view window 72, with or without associated view tools 74, which encompasses one or more structures of interest. Because the structure 76 is centered within the view window 72, the structure 76 is not obscured by the VAT 70 but may instead be reviewed without obstruction or distraction.

The view window 72 may be implemented such that it provides a magnified view of the structures 76 located within the window. In one embodiment, the operator may be able to select whether a magnified view is activated via an input device of the operator interface 22, such as a mouse, keyboard, touchpad, or touch sensitive display. For example, the operator may use a mouse to select controls disposed as view tools 74 on the VAT 70 or may instead use the mouse to select menu options or controls located on a toolbar forming part of the display interface. Similarly, the operator may be able to select whether the tools 74 are displayed with the view window 72, as depicted in FIG. 5, and whether the full perimeter of the window 72 is displayed, as depicted in FIG. 6, via an input device. In implementations in which the view window 72 is displayed without view tools 74, the periphery of the view window may shaded or colored in different manners to indicate different classifications or probabilities associated with the identified structure 76, thereby providing additional information to the reviewing operator.

In a presently contemplated embodiment, the VAT 70 appears for the user when the CAD results are selected for viewing. Other implementations, however, may allow the user to selectively view or hide the VAT, fade the VAT in or out, and so forth, to facilitate reading of the underlying image. In a typical application, a radiologist will view a number of such images, which will be processed either in real time or, to provide more efficient and timely computation and display, preprocessed and stored with the CAD results. The radiologist then calls the image or image sequence for display, views the images and CAD results, manipulates the results as described below, and completes the reading operation (typically resulting in dictation of diagnosis results). It should be noted, however, that the VAT may be employed in other contexts and in other ways, even in a medical imaging context. For example, such tools may be employed in real time, such as for image guided surgery, image acquisition, and so forth.

In addition, for clusters or groups of structures 76 the view window 72 may be enlarged, as depicted in FIG. 7, to encompass them. The enlarged view window 72 may be automatically selected by the system to present the CAD results or may be selected by the operator via an input device, as discussed above. Likewise, the enlarged viewing window 72 may be used with or without the associated view tools 74.

By positioning the view window 72 such that structures 76 of interest are located within the window 72, the focus of the operator remains on the structure 76, not on the surrounding tissue. Indeed, the surrounding tissue may be obscured by the view tools 74 or by the perimeter of the view window 72. In one embodiment, image regions outside of the view windows 74 may be displayed with diminished intensity or as solid or opaque regions to discourage or prevent unnecessary review of the regions not selected by the CAD algorithm for review. Such features may also be implemented selectively by the operator via an input device.

The view tools 74 may encompass a wide variety of functions based upon operator preference. Indeed, a customized set of tools 74 may be displayed for that operator based upon the preferences provided by that operator. In one embodiment, the view tool 74 may display the one or more settings 78, as depicted in FIG. 4, which reflect the current CAD configuration as specified by the operator. For example, the view tool 74 may display such settings as sensitivity 80 and specificity 82 which may each reflect logic, such as thresholds and mathematical assumptions, built into the CAD diagnosis by the parameters specified by the individual operator. The operator may choose which settings 78, if any, are displayed with the view tools 74 based upon the preferences of the operator, and may, in one embodiment, alter the setting from the view tools 74 such that the image data 48 is re-processed by the CAD algorithm using a different thresholds and assumptions. Indeed, if different CAD algorithms are available to the operator, as will be discussed in greater detail below, the operator may configure which setting 78 are displayed on the view tool 74 for each different algorithm.

In addition the view tool 74 may provide the relevant information, as determined by the operator, for diagnosis or review of the processed image data. For example, the view tool 74 may display one or more measures of CAD certainty or probability 84, such as pretest probability 86 or CAD probability 88, which assist an operator or radiologist in reviewing the image data 48. The displayed probability 84 may relate either the detection or classification of the displayed structure 76, depending on the aspect of the CAD process which is under review by the operator. The CAD probability, for example, may be based upon CAD training, as discussed above, and may also be customized for each operator to consider previous diagnoses and propensities of the operator. If other operators or radiologists have reviewed the data, their diagnosis and a measure of their certainty, if provided, may also be displayed on the view tools 74 to assist a reviewing radiologist.

The view tool 74 may also display one or more selectable options 90 which an operator or radiologist may choose after reviewing the selected structure 76. For example, the view tool 74 may provide the operator with options for acknowledging that the operator has reviewed the identified structure 76 and that the operator concurs, disagrees, or is non-committal with respect to the CAD result. Based upon the operator acknowledgement, the VAT 70 may then be removed from the display or focus shifted to other displayed VAT's 70. In instances, where the view window 72 encompasses more than one structure 76, such as is depicted in FIG. 7, the structure 76 to be acknowledged may be indicated by a visual marker, by highlighting, or the window 72 may be moved as structures 76 are acknowledged to keep the current structure 76 centered, allowing the operator to individually address each identified structure 76. In addition, an option may be provided on the view tool 74 to acknowledge all structures 76 encompassed by the view window 72 in a certain manner, i.e. concur, disagree, non-committal.

As noted above and with reference to FIG. 3, multiple CAD algorithms may be available for processing image data 48. An additional feature which may therefore be incorporated into the view tool 74 is the ability to toggle between the various CAD algorithm results. In one embodiment, the image data 48 is processed by each CAD algorithm prior to review by the operator, thus allowing the operator to merely toggle between results. In other embodiments, however, the image data 48 is processed according to the selected CAD algorithm upon selection of that algorithm by the operator.

The ability of the operator to toggle between CAD results may be implemented on the view tool 74 as a series of toggle buttons 92 or may be similarly implemented on a toolbar or drop down menu of the display interface. The operator may then use an input device as discussed above, such as a mouse, to select the desired set of algorithm results. In this manner, an operator may evaluate a particular structure 76 by evaluating the results generated by more than one CAD algorithm as opposed to a single algorithm.

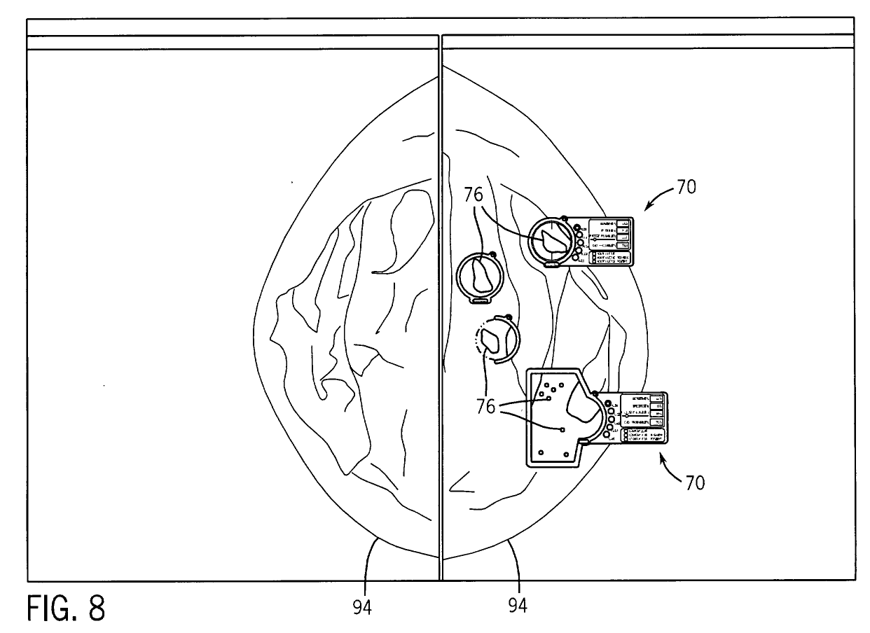

An example of the present technique is depicted in FIG. 8, in which a series of mammographic images 94 are presented as line drawings with various implementations of the VAT 70 identifying various structures 76 of interest. As depicted, a VAT 70 may be displayed for each identified structure 76 or cluster of structures 76 identified in the displayed images. In another embodiment, a single VAT 70 may be displayed at one time which, upon acknowledgement of the identified structure 76 by the operator, is moved to identify a subsequent structure 76. In addition, the VAT 70 may be disabled or hidden, if desired by the operator, to allow the operator to perform a manual reading or validation on the image data 48.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

What is claimed is:

1. A method for facilitating review of a computer-processed image, comprising:
displaying a computer-processed image, wherein the computer-processed image comprises one or more structures selected by a computer routine; and
displaying at least one visual aid tool comprising a viewing window such that the viewing window encompasses one or more structures.

2. The method as recited in claim 1, wherein the viewing window magnifies the encompassed one or more structures.

3. The method as recited in claim 2, further comprising selecting a magnification level.

4. The method as recited in claim 1, further comprising reducing the intensity of a portion of the computer-processed image outside of the viewing window.

5. The method as recited in claim 1, further comprising displaying a portion of the computer-processed image outside of the viewing window as opaque.

6. The method as recited in claim 1, further comprising differentially displaying a periphery of the viewing window in response to a characteristic of at least one structure encompassed by the viewing window.

7. The method as recited in claim 6, wherein differentially displaying the periphery comprises adjusting at least one of a shading, a color and a shape of the periphery in response to the characteristic.

8. The method as recited in claim 1, wherein the viewing window may be enlarged to encompass one or more additional structures of interest.

9. The method as recited in claim 1, wherein the at least one visual aid tool further comprises a set of viewing tools.

10. The method as recited in claim 9, further comprising customizing the set of viewing tools to correspond to an operator preference.

11. The method as recited in claim 9, wherein the set of viewing tools comprises one or more settings for a current CAD configuration.

12. The method as recited in claim 11, further comprising adjusting the one or more settings for the current CAD configuration.

13. The method as recited in claim 9, wherein the set of viewing tools comprises one or more diagnostic measures derived for at least one structure encompassed within the viewing window.

14. The method as recited in claim 13, wherein the one or more diagnostic measures comprises a measure of probability.

15. The method as recited in claim 9, wherein the set of viewing tools comprises one or more selectable options.

16. The method as recited in claim 15, wherein the one or more selectable options comprises an acknowledgement which may be selected by an operator.

17. The method as recited in claim 1, further comprising selecting the computer routine from one or more potential computer routines.

18. The method as recited in claim 17, wherein selecting the computer routine comprises selecting an option located on the viewing tool.

19. The method as recited in claim 17, wherein selecting the computer routine comprises selecting an option located on a display menu.

20. A method for reviewing a computer-processed image, comprising:
viewing a first set of CAD results generated by a first CAD algorithm;
selecting a second CAD algorithm; and
viewing a second set of CAD results generated by the second CAD algorithm.

21. The method as recited in claim 20, wherein selecting the second CAD algorithm comprises selecting an option located on the viewing tool.

22. The method as recited in claim 20, wherein selecting the second CAD algorithm comprises selecting an option located on a display menu.

23. An image analysis system, comprising:
data processing circuitry configured to apply at least one computer analysis routine to an image data set to produce a respective computer-processed image data set comprising one or more structures selected by the computer analysis routine; and
an operator interface configured to display the respective computer-processed image data set and to display at least one visual aid tool comprising a viewing window which encompasses at least one structure.

24. The image analysis system as recited in claim 23, wherein the viewing window magnifies the encompassed one or more structures.

25. The image analysis system as recited in claim 24, wherein the operator interface is further configured to allow an operator to select a magnification level.

26. The image analysis system as recited in claim 23, wherein the operator interface is further configured to reduce the intensity of a portion of the computer-processed image data set outside of the viewing window.

27. The image analysis system as recited in claim 23, wherein the operator interface is further configured to display a portion of the computer-processed image data set outside of the viewing window as opaque.

28. The image analysis system as recited in claim 23, wherein the operator interface is further configured to differentially display a periphery of the viewing window in response to a characteristic of at least one structure encompassed by the viewing window.

29. The image analysis system as recited in claim 28, wherein the operator interface differentially displays the periphery by adjusting at least one of a shading, a color and a shape of the periphery in response to the characteristic.

30. The image analysis system as recited in claim 23, wherein the operator interface is further configured to enlarge the viewing window to encompass one or more additional structures of interest.

31. The image analysis system as recited in claim 23, wherein the at least one visual aid tool further comprises a set of viewing tools.

32. The image analysis system as recited in claim 31, wherein the operator interface is further configured to allow customization of the set of viewing tools to correspond to an operator preference.

33. The image analysis system as recited in claim 31, wherein the set of viewing tools comprises one or more settings for a current CAD configuration.

34. The image analysis system as recited in claim 33, wherein the operator interface is further configured to allow adjustment of the one or more settings.

35. The image analysis system as recited in claim 31, wherein the set of viewing tools comprises one or more diagnostic measures derived for at least one structure encompassed within the viewing window.

36. The image analysis system as recited in claim 35, wherein the one or more diagnostic measures comprises a measure of probability.

37. The image analysis system as recited in claim 31, wherein the set of viewing tools comprises one or more selectable options.

38. The image analysis system as recited in claim 37, wherein the one or more selectable options comprises an acknowledgement which may be selected by an operator.

39. The image analysis system as recited in claim 23, wherein the operator interface is further configured to allow the selection of the at least one computer analysis routine from one or more potential computer routines.

40. The image analysis system as recited in claim 39, wherein selecting the computer routine comprises selecting an option located on the viewing tool.

41. The image analysis system as recited in claim 39, wherein selecting the computer routine comprises selecting an option located on a display menu.

42. The image analysis system as recited in claim 23, further comprising:
an imager;
system control circuitry configured to operate the imager; and
data acquisition circuitry configured to receive the image data set from the imager.

43. An image analysis system, comprising:
data processing circuitry configured to apply a first CAD algorithm to an image data set to generate a first set of CAD results and to apply a second CAD algorithm to the image data set to generate a second set of CAD results; and
an operator interface configured to allow an operator to select one of the first set of CAD results and the second set of CAD results for display.

44. The image analysis system as recited in claim 43, wherein the operator selects an option located on a displayed viewing tool to select one of the first set of CAD results and the second set of CAD results for display.

45. The image analysis system as recited in claim 43, wherein the operator selects an option located on a display menu to select one of the first set of CAD results and the second set of CAD results for display.

46. The image analysis system as recited in claim 43, further comprising:
an imager;
system control circuitry configured to operate the imager; and
data acquisition circuitry configured to receive the image data set from the imager.

47. An image analysis system, comprising:
data processing circuitry configured to apply at least one computer analysis routine to an image data set to produce a respective computer-processed image data set comprising one or more structures selected by the computer analysis routine; and
an operator interface comprising a means for displaying a visual aid tool in conjunction with the respective computer processed data set.

48. The image analysis system as recited in claim 47, wherein the operator interface further comprises a means for selecting an alternate computer analysis routine.

49. The image analysis system as recited in claim 47, further comprising:
an imager;
system control circuitry configured to operate the imager; and
data acquisition circuitry configured to receive the image data set from the imager.

50. An image analysis system, comprising:
data processing circuitry configured to apply a selected CAD algorithm from two or more possible CAD algorithms to an image data set to generate a selected set of CAD results; and
an operator interface comprising a means for selecting the selected CAD algorithm.

51. The image analysis system as recited in claim 50, further comprising:
an imager;
system control circuitry configured to operate the imager; and
data acquisition circuitry configured to receive the image data set from the imager.

52. A tangible medium for facilitating review of a computer-processed image, comprising:
a routine for displaying a computer-processed image, wherein the computer-processed image comprises one or more structures selected by a computer routine; and
a routine for displaying at least one visual aid tool comprising a viewing window such that the viewing window encompasses one or more structures.

53. The tangible medium as recited in claim 52, wherein the viewing window magnifies the encompassed one or more structures.

54. The tangible medium as recited in claim 53, further comprising a routine for selecting a magnification level.

55. The tangible medium as recited in claim 52, further comprising a routine for reducing the intensity of a portion of the computer-processed image outside of the viewing window.

56. The tangible medium as recited in claim 52, further comprising a routine for displaying a portion of the computer-processed image outside of the viewing window as opaque.

57. The tangible medium as recited in claim 52, further comprising a routine for differentially displaying a periphery of the viewing window in response to a characteristic of at least one structure encompassed by the viewing window.

58. The tangible medium as recited in claim 57, wherein the routine for differentially displaying the periphery adjusts at least one of a shading, a color and a shape of the periphery in response to the characteristic.

59. The tangible medium as recited in claim 52, wherein the viewing window may be enlarged to encompass one or more additional structures of interest.

60. The tangible medium as recited in claim 52, wherein the at least one visual aid tool further comprises a set of viewing tools.

61. The tangible medium as recited in claim 60, further comprising a routine for customizing the set of viewing tools to correspond to an operator preference.

62. The tangible medium as recited in claim 60, wherein the set of viewing tools comprises one or more settings for a current CAD configuration.

63. The tangible medium as recited in claim 62, further comprising a routine for adjusting the one or more settings for the current CAD configuration.

64. The tangible medium as recited in claim 60, wherein the set of viewing tools comprises one or more diagnostic measures derived for at least one structure encompassed within the viewing window.

65. The tangible medium as recited in claim 64, wherein the one or more diagnostic measures comprises a measure of probability.

66. The tangible medium as recited in claim 60, wherein the set of viewing tools comprises one or more selectable options.

67. The tangible medium as recited in claim 66, wherein the one or more selectable options comprises an acknowledgement which may be selected by an operator.

68. The tangible medium as recited in claim 52, further comprising a routine for selecting the computer routine from one or more potential computer routines.

69. The tangible medium as recited in claim 68, wherein selecting the computer routine comprises selecting an option located on the viewing tool.

70. The tangible medium as recited in claim 68, wherein selecting the computer routine comprises selecting an option located on a display menu.

71. A tangible medium for reviewing a computer-processed image, comprising:
a routine for viewing a first set of CAD results generated by a first CAD algorithm;
a routine for selecting a second CAD algorithm; and
a routine for viewing a second set of CAD results generated by the second CAD algorithm.

72. The tangible medium as recited in claim 71, wherein selecting the second CAD algorithm comprises selecting an option located on the viewing tool.

73. The tangible medium as recited in claim 71, wherein selecting the second CAD algorithm comprises selecting an option located on a display menu.
